(19) United States
(12) Patent Application Publication
(10) Pub. No.: US 2025/0283441 A1
(43) Pub. Date: Sep. 11, 2025

(54) METHOD OF PERFORMING A TREATMENT PROCESS ON AN INTERNAL COMBUSTION ENGINE, AND AN INTERNAL COMBUSTION ENGINE SYSTEM

(71) Applicant: CUMMINS INC., Columbus, IN (US)

(72) Inventors: Ryan Edward Denton, Franklin, IN (US); Jennifer Light-Holets, Columbus, IN (US); Wei Qin, Columbus, IN (US)

(73) Assignee: CUMMINS INC., Columbus, IN (US)

(21) Appl. No.: 19/061,826

(22) Filed: Feb. 24, 2025

Related U.S. Application Data
(60) Provisional application No. 63/562,107, filed on Mar. 6, 2024.

(51) Int. Cl. F02M 25/06; F02D 19/06

(52) U.S. Cl. CPC F02M 25/06; F02D 19/0615

(57) ABSTRACT

A method includes determining an extent of usage of the internal combustion engine. The method includes comparing the extent of usage with a threshold value. In response to determining that the extent of usage is below the threshold value, the method includes operating the internal combustion engine under a first condition during which a lubricating oil in the internal combustion engine is combusted to form a combustion by-product. The method further includes operating the internal combustion engine under a second condition during which the combustion by-product is deposited onto components of the internal combustion engine.

### CROSS-REFERENCE TO RELATED APPLICATIONS

This application claims the benefit of and priority to U.S. Provisional Patent Application No. 63/562,107, filed on Mar. 6, 2024, the contents of which are incorporated herein by reference in their entirety for all purposes.

### TECHNICAL FIELD

The present invention relates generally to internal combustion engines and methods of performing a treatment on the same.

### BACKGROUND

Internal combustion engines (ICEs) operate via the controlled ignition of air and fuel within a cylinder (e.g., a combustion cylinder, a combustion chamber, etc.), relying on several moving components along the way. These moving components can be configured to perform alternating or continuing movements at extremely high speeds, up to several thousand cycles per minute. As such, ICEs also rely on a continuing distribution of lubricating oils in order to reduce friction and wear between their various moving components.

### SUMMARY OF THE INVENTION

One aspect of the present disclosure relates to a method of performing a treatment process on an internal combustion engine. The method includes determining an extent of usage of the internal combustion engine. The method includes comparing the extent of usage with a threshold value. In response to determining that the extent of usage is below the threshold value, the method includes operating the internal combustion engine under a first condition during which a lubricating oil in the internal combustion engine is combusted to form a combustion by-product. The method further includes operating the internal combustion engine under a second condition during which the combustion by-product is deposited onto components of the internal combustion engine.

The method may further include providing the internal combustion engine with a treatment oil before operating the internal combustion engine under the first condition such that the lubricating oil includes the treatment oil. The treatment oil may include an ash additive. The providing the internal combustion engine with the treatment oil may include determining an amount of the ash additive in the treatment oil based on the determined extent of usage. The operating of the internal combustion engine under the first condition may include subjecting the internal combustion engine to a first load. The operating of internal combustion engine under the second condition may include subjecting the internal combustion engine to a second load that is greater than the first load. The operating of the internal combustion engine under the first condition and the operating of the internal combustion engine under the second condition may be implemented cyclically. The method may further include, after operating the internal combustion engine under the second condition, operating the internal combustion engine under routine conditions.

The determining of the extent of usage may include determining at least one of mileage and operating time of the internal combustion engine. The determining of the extent of usage is relative to a baseline condition that may correspond to a condition of the internal combustion engine after initial production is completed, a rebuild of the internal combustion engine, or a replacement of a key component of the internal combustion engine.

Where the threshold value is a first threshold value, the method may further include, in response to determining that the extent of usage is above the first threshold value, determining an amount of the lubricating oil consumed by the internal combustion engine. The method may include comparing the amount with a second threshold value. The method may include, in response to determining that the amount is at or above the second threshold value, operating the internal combustion engine under the first condition and subsequently operating the internal combustion engine under the second condition. The method may further include, in response to determining that the amount is at or above the second threshold value, providing the internal combustion engine with a treatment oil before operating the internal combustion engine under the first condition such that the lubricating oil includes the treatment oil. The treatment oil may include an ash additive. The providing the internal combustion engine with the treatment oil may include determining an amount of the ash additive in the treatment oil based on the amount of the lubricating oil consumed.

Another aspect of the present disclosure relates to a method of performing a treatment process on an internal combustion engine. The method includes determining an amount of a lubricating oil consumed by the internal combustion engine. In response to determining that the amount is at or above the threshold value, the method includes operating the internal combustion engine under a first condition during which the lubricating oil in the internal combustion engine is combusted to form a combustion by-product. The method further includes operating the internal combustion engine under a second condition during which the combustion by-product is deposited onto components of the internal combustion engine.

Where the threshold value is a first threshold value, the method may further include, before determining the amount of the lubricating oil consumed, determining that an extent of usage of the internal combustion engine is above a second threshold value. The determining of the extent of usage may include tracking the extent of usage using an engine hour counter or a mileage counter. The method may further include, before operating the internal combustion engine under the first condition, providing the internal combustion engine with the lubricating oil, where the lubricating oil may include an ash additive and a standard oil.

The providing the internal combustion engine with the lubricating oil may include dosing the standard oil with the ash additive. The providing the internal combustion engine with the lubricating oil may include filling the internal combustion engine with a mixture of a treatment oil and the standard oil, where the treatment oil includes the ash additive. The providing the internal combustion engine with the lubricating oil may further include determining an amount of the ash additive in the lubricating oil based on the amount of the lubricating oil consumed.

The operating of the internal combustion engine under the first condition may include operating the internal combustion engine at a low-duty cycle and the operating of internal combustion engine under the second condition may include operating the internal combustion engine at a high-duty cycle. The operating of the internal combustion engine under the first condition and the operating of the internal combustion engine under the second condition may be implemented cyclically. The operating the internal combustion engine under the first condition may include adjusting an amount of the lubricating oil metered in the internal combustion engine. The method may further include, in response to determining that the amount is at or above the threshold value, operating the internal combustion engine under routine conditions.

Yet another aspect of the present disclosure relates to an internal combustion engine system. The internal combustion engine system includes an internal combustion engine and a controller communicatively coupled to the internal combustion engine. The controller is configured to determine an extent of usage of the internal combustion engine relative to a threshold value. In response to determining that the extent of usage is at or below the threshold value, the controller is configured to operate the internal combustion engine under a first condition during which a lubricating oil in the internal combustion engine is combusted to form a combustion by-product. The controller is further configured to operate the internal combustion engine under a second condition during which a temperature within the internal combustion engine is increased, thereby depositing the combustion by-product onto components of the internal combustion engine. The internal combustion engine system may further include at least one sensor communicatively coupled to the internal combustion engine and the controller. The controller may be configured to determine the extent of usage based on data received from the at least one sensor that correspond to the extent of usage of the internal combustion engine.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a block diagram of an engine (e.g., an internal combustion engine) system, according to an example embodiment.

FIG. 2 is a block diagram showing components of an engine as a part of the engine system of FIG. 1, according to an example embodiment.

FIG. 3 is a flow diagram of a method of performing a treatment process in an engine, according to an example embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

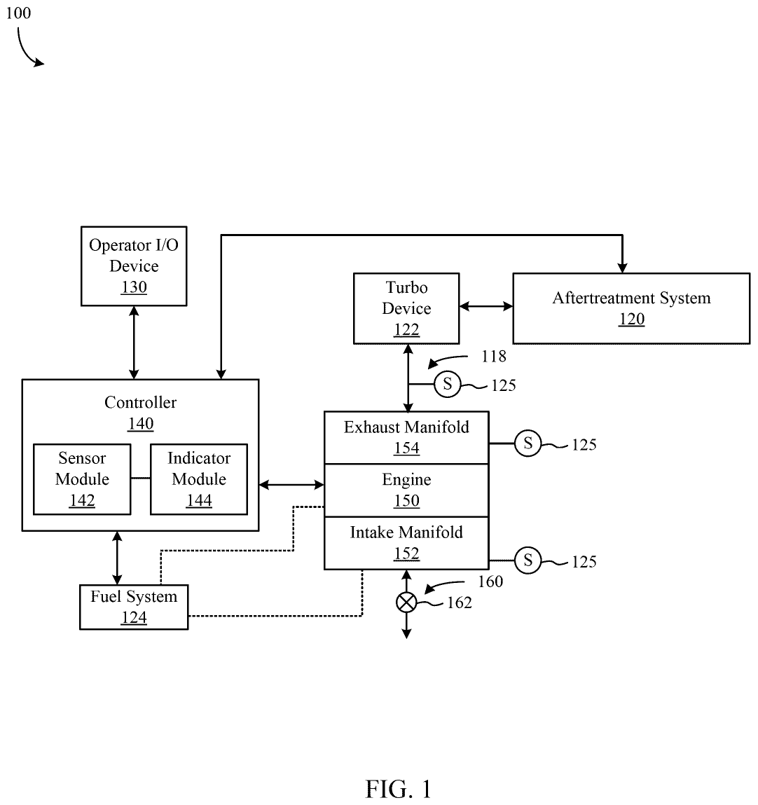

Referring to FIG. 1, a schematic view of a block diagram of an engine system 100, alternatively referred to as an internal combustion engine system 100, is shown, according to an example embodiment. The engine system 100 includes an engine 150, alternatively referred to as an internal combustion engine 150, and an aftertreatment system 120 in exhaust gas receiving communication with the engine 150. In some embodiments, the engine system 100 also includes a turbo device 122 disposed between the engine 150 and the aftertreatment system 120, such that the turbo device 122 is in exhaust gas receiving communication with the engine 150 and exhaust gas providing communication with the aftertreatment system 120. In these embodiments, the aftertreatment system 120 is in exhaust gas receiving communication with the engine 150 via the turbo device 122. The engine system 100 may include a plurality of sensors 125 communicatively coupled to at least the engine 150. The engine system 100 also includes a controller 140 and an operator input/output (I/O) device 130, where the controller 140 is communicably coupled to at least the engine 150, the aftertreatment system 120, the sensors 125, and the operator I/O device, for example. In this regard, operations of the aforementioned components, including at least the engine 150, the sensors 125, and the aftertreatment system 120, are implemented by the controller 140.

In the configuration of FIG. 1, the engine system 100 is included in a vehicle. The vehicle may be any type of on-road or off-road vehicle including, but not limited to, wheel-loaders, fork-lift trucks, line-haul trucks, mid-range trucks (e.g., pick-up truck, etc.), sedans, coupes, tanks, airplanes, boats, and any other type of vehicle. In another embodiment, the engine system 100 may be embodied in a stationary piece of equipment, such as a power generator or genset. All such variations are intended to fall within the scope of the present disclosure.

In some embodiments, the engine 150 is an internal combustion engine (ICE) that consumes a non-hydrocarbon-based (e.g., hydrogen) or a low-hydrocarbon-based fuel to generate power. In this regard, the engine 150 is considered a hydrogen ICE. In some embodiments, the engine 150 consumes a combination of a non-hydrocarbon-based fuel and a hydrocarbon-based fuel (e.g., gasoline, diesel, etc.). In this regard, the engine 150 is considered a dual-fuel ICE. In other embodiments, the engine 150 may be part of a hybrid engine system having a combination of an internal combustion engine and at least one electric motor coupled to at least one battery. In some embodiments, the hybrid engine system may be configured as a mild-hybrid powertrain, a parallel hybrid powertrain, a series hybrid powertrain, or a series-parallel powertrain. The engine 150 may be alternatively referred to as the internal combustion engine (ICE) 150 in the present disclosure.

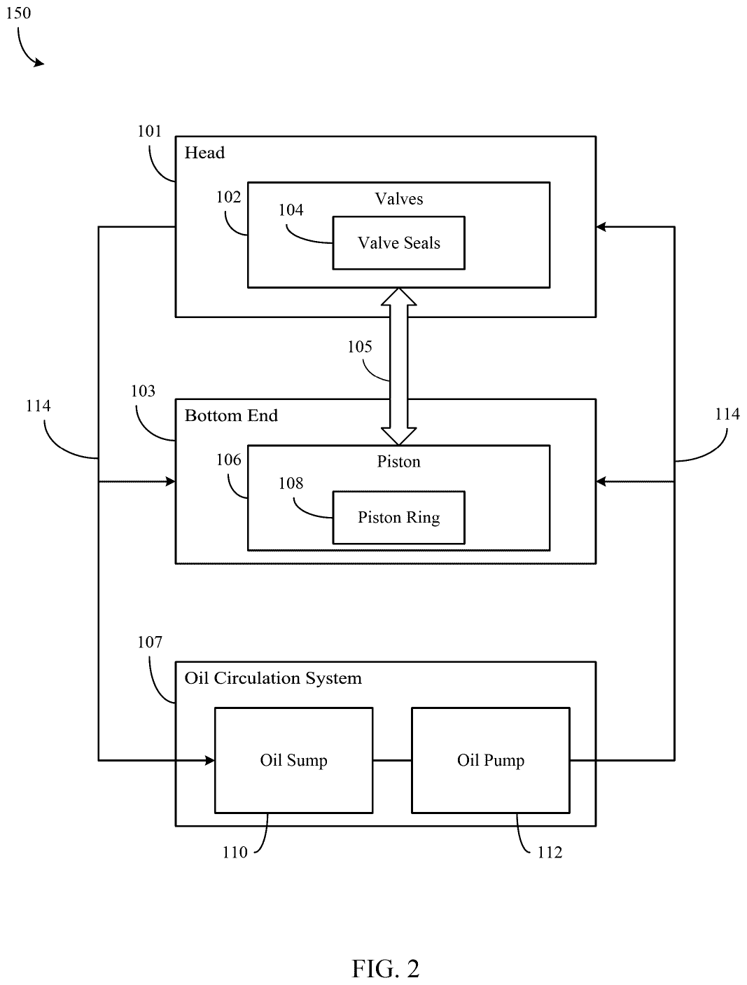

The engine 150 includes one or more cylinders (e.g., combustion cylinder, combustion chamber; see cylinder 105 depicted in FIG. 2). In some embodiments, each cylinder has a corresponding igniter (e.g., spark plug, glow plug, etc.; not depicted separately). The igniter is configured to ignite fuel (e.g., hydrogen) within a corresponding cylinder. In some embodiments, the engine 150 is a compression ignition engine.

The engine system 100 includes an intake conduit 160 and an intake manifold 152. The intake conduit is configured to route an intake gas stream, including air (e.g., ambient air), to the intake manifold 152. The intake manifold 152 is configured to route the intake gas stream from an intake conduit 160 into the engine 150.

The engine system 100 includes an intake air throttle (IAT) valve 162. The IAT valve 162 is disposed at the intake conduit 160 and upstream of the intake manifold 152. The IAT valve 162 is structured to control an amount of air supplied to the engine 150. The IAT valve 162 may be actuated (e.g., by an actuator controlled by the controller 140) between an open position and a closed position. In the open position, the IAT valve 162 allows a maximum amount of air to flow from the air intake to the engine 150. In the closed position, the IAT valve 162 allows a minimum amount of air to flow from the air intake to the engine 150. The controller 140 may selectively actuate the IAT valve 162 (e.g., by controlling the actuator) in a plurality of positions between and/or including the open position and the closed position to adjust the amount of air received by the engine 150. In some embodiments, the IAT valve 162 is operable to control an amount and/or timing of air provided to the engine 150 to achieve a target air to fuel ratio (AFR). For example, the controller 140 may control the IAT valve 162 to adjust an amount of air provided to the engine 150 relative to an amount of fuel provided to the engine 150.

The engine system 100 includes an exhaust manifold 154 and an exhaust conduit 118. The exhaust manifold 154 is configured to route an exhaust gas stream from the engine 150 to the exhaust conduit 118. More specifically, the exhaust manifold 154 is configured to route an exhaust gas stream from each of the cylinders (e.g., one or more of the cylinders 105) to the exhaust conduit 118. The exhaust conduit 118 is configured to route the exhaust gas stream from the exhaust manifold 154 to a downstream component, such as the aftertreatment system 120 and/or the turbo device 122. In some embodiments, a first portion of the exhaust conduit 118 is disposed between the exhaust manifold 154 and turbo device 122. The first portion of the exhaust conduit 118 is configured to route the exhaust gas stream from the exhaust manifold 154 to turbo device 122. In some embodiments, a second portion of the exhaust conduit 118 is disposed between the turbo device 122 and the aftertreatment system 120. The second portion of the exhaust conduit 118 is configured to route the exhaust gas stream from the turbo device 122 to the aftertreatment system 120.

The aftertreatment system 120 is in exhaust gas receiving communication with the engine 150. The aftertreatment system 120 includes components used to reduce exhaust emissions, such as a selective catalytic reduction (SCR) catalyst, an oxidation catalyst (DOC), a particulate filter (DPF), an exhaust fluid doser with a supply of exhaust fluid, a plurality of sensors for monitoring the aftertreatment system (e.g., a nitrogen oxide (NOx) sensor, temperature sensors, etc.), and/or still other components.

The turbo device 122 may be any type of turbo machinery, such as a turbocharger, a supercharger, a variable geometry turbocharger, a power turbine, etc. The turbo device 122 may be operatively coupled to the engine 150 and/or another component of the engine system 100, such as a drivetrain, a battery, an electric machine, or other suitable component.

The engine system 100 also includes a fuel system 124. The fuel system 124 is configured to provide fuel (e.g., hydrogen) to the engine 150. More specifically, the fuel system 124 is configured to provide fuel to each of the one or more cylinders in the engine 150. The fuel system 124 may include one or more components for providing the fuel to the engine 150, such as a storage tank for storing the fuel, one or more regulators (e.g., valves, solenoids, etc.) for controlling an amount or a timing of fuel provided to the engine 150, and/or a fuel injector. In some embodiments, the fuel injector is provided at the intake manifold 152. In other embodiments, the fuel system 124 includes a separate fuel injector for each cylinder such that the fuel system 124 directly injects the fuel into each of the cylinders.

In some embodiments, the controller 140 is operatively coupled to the fuel system 124 such that the controller 140 may control the operation of the fuel system 124. More specifically, the controller 140 may control the fuel system 124 to control an amount and/or a timing of fuel provided to the engine 150. In some embodiments, the fuel system 124 is operable to control an amount and/or timing of fuel provided to the engine 150 to achieve a target AFR. For example, the controller 140 may control the fuel system 124 to adjust an amount of fuel provided to the engine 150 relative to an amount of air provided to the engine 150.

As shown, the sensors 125 are communicatively coupled to the engine 150 and the controller 140. The number, placement, and type of sensors included in the engine system 100 is shown for example purposes only. That is, in other configurations, the number, placement, and type of sensors may differ. The sensors 125 may be gas constituent sensors (e.g., NOx sensors, oxygen sensors, H₂O/humidity sensors, etc.), temperature sensors, particulate matter (PM) sensors, flow rate sensors (e.g., mass flow rate sensors, volumetric flow rate sensors, etc.), other exhaust gas emissions constituent sensors, pressure sensors, some combination thereof, and so on. As shown in FIG. 1, the sensors 125 may be located at or proximate the intake conduit 160, the intake manifold 152, the exhaust manifold 154, and the exhaust conduit 118. It should be understood that the location of the sensors may vary, and the engine system 100 may include more or fewer sensors than as shown in FIG. 1. In one embodiment, the engine system 100 may include sensors 125 located both before and after the aftertreatment system 120.

The sensors 125 may also include engine-related sensors (e.g., oil sensors, torque sensors, speed sensors, pressure sensors, flowrate sensors, temperature sensors, etc.). Specifically, the sensors 125 may include engine-related sensors configured to collect data corresponding to an extent of usage of the engine 150. For example, the sensors 125 may include engine-related sensors configured to measure data corresponding to the amount of operating time (i.e., engine hour), the number of mileage, or both. The sensors 125 may further include sensors associated with other components of the vehicle, such as the aftertreatment system 120, the turbo device 122, or the fuel system 124. For example, the sensor may include speed sensor of the turbo device 122, a fuel quantity and injection rate sensor, fuel rail pressure sensor, etc.).

The sensors 125 may be real or virtual (i.e., a non-physical sensor that is structured as program logic in the controller 140 that makes various estimations or determinations). For example, an engine speed sensor may be a real or virtual sensor arranged to measure or otherwise acquire data, values, or information indicative of a speed of the engine 150 (typically expressed in revolutions-per-minute). The sensor is coupled to the engine (when structured as a real sensor) and is structured to send a signal to the controller 140 indicative of the speed of the engine 150. When structured as a virtual sensor, at least one input may be used by the controller 140 in an algorithm, model, lookup table, etc. to determine or estimate a parameter of the engine (e.g., power output, etc.). Any of the sensors 125 described herein may be real or virtual.

The controller 140 is coupled, and particularly communicably coupled, to the sensors 125. Accordingly, the controller 140 is structured to receive data from one more of the sensors 125 and provide instructions/information to the one or more sensors 125. The received data may be used by the controller 140 to control one more components in the engine system 100, including the engine 150, and/or for monitoring and thermal management purposes.

The operator input/output (I/O) 130 device may be coupled to the controller 140, such that information may be exchanged between the controller 140 and the operator I/O device 130, where the information may relate to one or more components of FIG. 1 or determinations (described below) of the controller 140. The operator I/O device 130 enables an operator of the engine system 100 to communicate with the controller 140 and one or more components of the engine system 100 of FIG. 1. For example, the operator I/O device 130 may include, but is not limited to, an interactive display, a touchscreen device, one or more buttons and switches, voice command receivers, etc. In this way, the operator input/output device may provide one or more indications or notifications to an operator, such as a malfunction indicator lamp (MIL), etc. Additionally, the vehicle may include a port that enables the controller 140 to connect or couple to a scan tool so that fault codes and other information regarding the vehicle may be obtained.

The controller 140 is structured to control, at least partly, the operation of the engine system 100 and associated sub-systems, such as the engine 150, the sensors 125, the aftertreatment system 120, and the operator I/O device 130, for example. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 140 is communicably coupled to the systems and components of FIG. 1, the controller 140 is structured to receive data from one or more of the components shown in FIG. 1.

In some embodiments, the controller 140 includes a processing circuit having a processor and a memory. The processing circuit may be structured or configured to execute or implement the instructions, commands, and/or control processes described herein with respect to one or more circuits in the controller 140, such as an engine circuit communicatively coupled to and structured to execute the instructions associated with the engine 150, where the circuits are embodied as machine or computer-readable media. The controller 140 may include various circuits associated with the components of the engine system 100. For example, the controller 140 may additionally include a sensor circuit and an operator I/O circuit, for example, communicatively coupled to and structured to execute the instructions associated with the sensors 125 and the operator I/O device 130, respectively. It is noted that this illustration is not meant to be limiting as the present disclosure contemplates other embodiments such as the aforementioned embodiment where the circuits are configured as a hardware unit or multiple hardware units. All such combinations and variations are intended to fall within the scope of the present disclosure.

In some embodiments, the controller 140 includes one or more modules structured to functionally execute the operations of the controller 140. A module may be implemented by way of hardware, firmware, software, the like, or combinations thereof (e.g., such as by a processor executing computer instructions from a non-transient computer readable storage medium). Modules may be distributed across various components.

Example and non-limiting module implementation components include sensors (e.g., the sensors 125) providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control components (springs, filters, integrators, adders, dividers, gain components), and/or digital control components.

As the components of FIG. 1 are shown to be embodied in the engine system 100, the controller 140 may be structured as one or more electronic control units (ECUs), such as one or more microcontrollers. The controller 140 may be separate from or included with at least one of a transmission control unit, an exhaust aftertreatment control unit, a powertrain control module, an engine control unit, an engine control module, etc.

Referring to FIG. 2, an example embodiment of the engine 150 is shown in a schematic block diagram. The engine 150 includes a head 101, a bottom end 103, and an oil circulation system 107. Components disposed within the head 101 and the bottom end 103 together allow for the operation of one or more of the cylinders 105. The cylinder 105 is a designated space within the engine where a controlled amount of air is collected along with a controlled amount of combustible fuel, and then ignited by a corresponding igniter (e.g., spark plug, glow plug, etc.; not depicted separately) or by compression of a combination of intake air and exhaust, as in the case of a compression ignition engine, for example. Upon ignition, the combustible fuel is spent and the collected air is converted into an exhaust gas and expelled from the cylinder 105.

The head 101 is configured to regulate flow of intake and exhaust gases from the cylinder 105. The head 101 can include a plurality of valves 102, and a corresponding plurality of intake ports and exhaust ports arranged as a part the intake manifold 152 and exhaust manifold 154, respectively. One of the valves 102 is disposed in each of the intake and exhaust ports and is configured to alternate between an open configuration (i.e., allowing flow into or out of the cylinder 105) and a closed configuration (i.e., preventing flow into or out of the cylinder 105). The valves 102 include a corresponding plurality of valve seals 104 which inhibit or prevent the flow of intake or exhaust gases when a given valve is in a closed configuration (e.g., preventing a flow between a port wall and the corresponding valve 102).

Each of the valves 102 physically contacts a valve seat located at a corresponding one of the intake and exhaust ports when the valve 102 transitions to the closed configuration. The valve seats, in combination with the valve seals 104, are configured to maintain a seal between the valves 102 and the intake and exhaust ports while the engine 150 is in operation. In this regard, the valve seat is subject to cyclic loading and friction for prolonged periods, posing a higher risk of wear and fatigue compared to other less or non-mobile parts in the engine 150. Accordingly, lubrication applied to components such as the valve seats is generally desirable for maintaining proper operation and increasing lifespan of the engine 150. In some examples, combustion of a hydrocarbon-based fuel (e.g., gasoline, diesel, etc.) in an ICE forms carbon-based (or carbon-containing) by-products that, upon being deposited onto the moving components, can act as a solid lubricant for such components as the valve seats to improve their resistance to wear.

The bottom end 103 of the engine 150 may contain the cylinders 105 and a corresponding piston 106 in each of the cylinders 105. The piston 106 is a cylinder concentrically disposed within the cylinder 105 and is allowed a one-dimensional range of movement within. The piston 106 includes at least one piston ring 108. The piston ring 108 is disposed within a corresponding annular groove disposed about the piston 106 and may be allowed a limited degree of movement relative to the piston 106.

The oil circulation system 107 is configured to provide a lubricant (e.g., motor oil) to various components of the head 101 and the bottom end 103. The oil circulation system 107 includes an oil sump 110, an oil pump 112, and oil conduits 114. The oil sump 110 is a designated area where oil distributed throughout the engine 150 is collected (e.g., an oil pan). The oil conduits 114 transport oil from the oil pump 112 to the head 101 and the bottom end 103, where the oil can then be distributed to components subject to significant amounts of friction over the course of normal engine operation (e.g., the piston 106 and piston ring 108, and the valves 102, valve seats, and valve seals 104). For example, oil can be used to lubricate the movement of the piston 106 within the cylinder 105, and the movement of the valves 102 in their respective intake or exhaust ports.

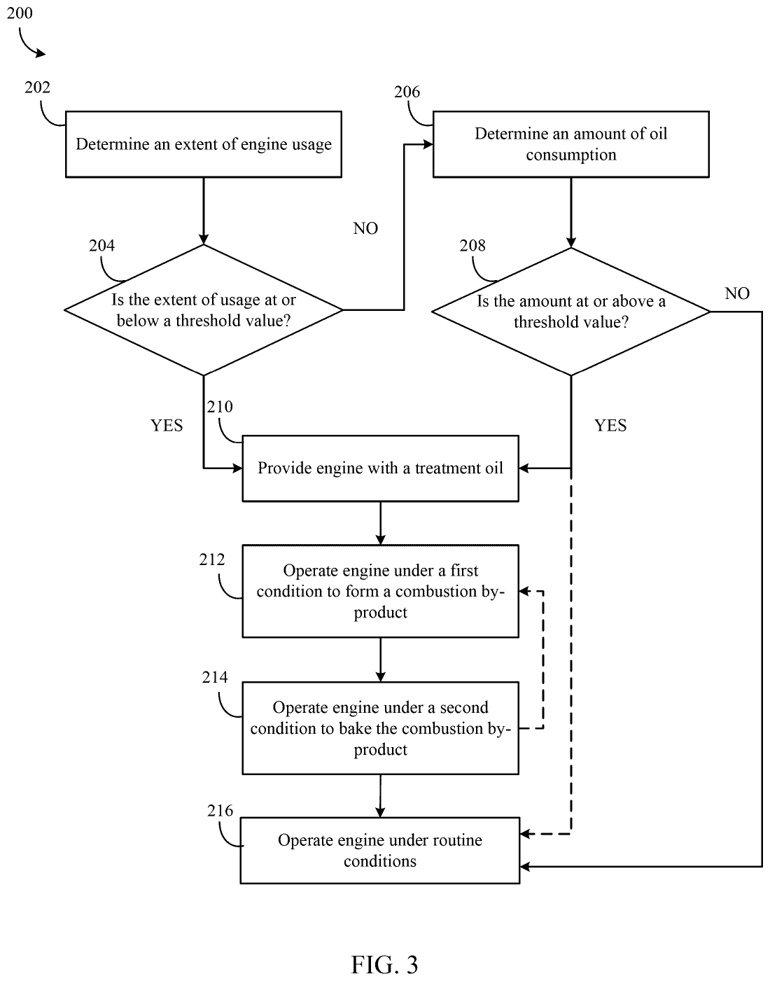

Referring to FIG. 3, a flow diagram of a method 200 of performing a treatment process in an engine (e.g., the engine 150) is shown. In some embodiments, the treatment process is referred to as a de-greening process for conditioning (or pre-conditioning, depending on a state of the engine discussed below) the engine to provide enhanced lubrication for components of the engine at higher risk of wear. It is noted that the method 200 is merely an example and is not intended to limit the present disclosure. Accordingly, additional operations may be provided before, during, and after the method 200 of FIG. 3.

In one aspect, the method 200 includes determining an extent of usage of the internal combustion engine at operation 202. The method 200 includes comparing the extent of usage with a threshold value at operation 204. In response to determining that the extent of usage is below the threshold value, the method includes, at operation 212, operating the internal combustion engine under a first condition during which a lubricating oil in the internal combustion engine is combusted to form a combustion by-product, and, at operation 214, operating the internal combustion engine under a second condition during which the combustion by-product is deposited onto components of the internal combustion engine.

The method 200 may further include, at operation 210, providing the internal combustion engine with a treatment oil before operating the internal combustion engine under the first condition such that the lubricating oil includes the treatment oil. The treatment oil may include an ash additive. The providing the internal combustion engine with the treatment oil at operation 210 may include determining an amount of the ash additive in the treatment oil based on the extent of usage as determined at operation 202. The operating of the internal combustion engine under the first condition at operation 212 may include subjecting the internal combustion engine to a first load. The operating of internal combustion engine under the second condition at operation 214 may include subjecting the internal combustion engine to a second load that is greater than the first load. The operating of the internal combustion engine under the first condition and the operating of the internal combustion engine under the second condition may be implemented cyclically. The method 200 may further include, after operating the internal combustion engine under the second condition at operation 214, operating the internal combustion engine under routine conditions at operation 216.

The determining of the extent of usage at operation 202 may include determining at least one of mileage and operating time of the internal combustion engine. The determining of the extent of usage at operation 202 is relative to a baseline condition that may correspond to a condition of the internal combustion engine after initial production is completed, a rebuild of the internal combustion engine, or a replacement of a key component of the internal combustion engine.

The method 200 may further include, in response to determining that the extent of usage is above the first threshold value at operation 204, determining an amount of the lubricating oil consumed by the internal combustion engine at operation 206. Where the threshold value being compared to at operation 204 is a first threshold value, the method 200 may include comparing the amount of the lubricating oil with a second threshold value at operation 208. The method 200 may further include, in response to determining that the amount is at or above the second threshold value, operating the internal combustion engine under the first condition at operation 212 and operating the internal combustion engine under the second condition at operation 214. The method 200 may further include, in response to determining that the amount is at or above the second threshold value, providing the internal combustion engine with a treatment oil before operating the internal combustion engine under the first condition at operation 210 such that the lubricating oil includes the treatment oil. The treatment oil may include an ash additive. The providing the internal combustion engine with the treatment oil at operation 210 may include determining an amount of the ash additive in the treatment oil based on the amount of the lubricating oil consumed as determined at operation 206.

In another aspect, the method 200 includes determining an amount of a lubricating oil consumed by the internal combustion engine at operation 206. In response to determining that the amount is at or above the threshold value at operation 208, the method 200 includes, at operation 212, operating the internal combustion engine under a first condition during which the lubricating oil in the internal combustion engine is combusted to form a combustion by-product. The method 200 further includes, at operation 214, operating the internal combustion engine under a second condition during which the combustion by-product is deposited onto components of the internal combustion engine.

Where the threshold value is a first threshold value, the method 200 may further include, before determining the amount of the lubricating oil consumed at operation 206, determining that an extent of usage of the internal combustion engine is above a second threshold value at operation 202. The determining of the extent of usage at operation 202 may include tracking the extent of usage using an engine hour counter or a mileage counter. The method 200 may further include, before operating the internal combustion engine under the first condition at operation 212, providing the internal combustion engine with the lubricating oil, where the lubricating oil may include an ash additive and a standard oil at operation 210.

The providing the internal combustion engine with the lubricating oil at operation 210 may include dosing the standard oil with the ash additive. The providing the internal combustion engine with the lubricating oil at operation 210 may include filling the internal combustion engine with a mixture of a treatment oil and the standard oil, where the treatment oil includes the ash additive. The providing the internal combustion engine with the lubricating oil at operation 210 may further include determining an amount of the ash additive in the lubricating oil based on the amount of the lubricating oil consumed as determined at operation 206.

The operating of the internal combustion engine under the first condition at operation 212 may include operating the internal combustion engine at a low-duty cycle and the operating of internal combustion engine under the second condition at operation 214 may include operating the internal combustion engine at a high-duty cycle. The operating of the internal combustion engine under the first condition at operation 212 and the operating of the internal combustion engine under the second condition at operation 214 may be implemented cyclically. The operating the internal combustion engine under the first condition at operation 212 may include adjusting an amount of the lubricating oil metered in the internal combustion engine. The method 200 may further include, in response to determining that the amount is at or above the threshold value at operation 208, operating the internal combustion engine under routine conditions at operation 216.

In yet another aspect, the engine system 100 (i.e., the internal combustion engine system 100) includes the internal combustion engine 150 (i.e., the engine 150) and a controller 140 communicatively coupled to the internal combustion engine 150. The controller 140 is configured to implement the method 200, including determining, at operation 202, an extent of usage of the internal combustion engine 150 relative to a threshold value. In response to determining that the extent of usage is at or below the threshold value at operation 204, the controller 140 is configured to operate the internal combustion engine under a first condition during which a lubricating oil in the internal combustion engine is combusted to form a combustion by-product at operation 212. The controller 140 is further configured to the internal combustion engine 150 under a second condition during which a temperature within the internal combustion engine 150 is increased, thereby depositing the combustion by-product onto components of the internal combustion engine.

After performing the treatment process, the method 200 proceeds to operating the engine under routine conditions at operation 216. Advantageously, the resulting combustion deposits can act as a solid lubricant for components of the engine prone to wear, leading to an improvement in the lifespan of the engine.

In various embodiments, the method 200 begins with determining whether a need to treat or condition the engine exists based on one or more operating parameters (e.g., amount of operating time, a number of miles traveled, etc.) of the engine at operations 202-208. At the operation 202, an extent of an engine's (the engine 150 hereafter) usage (or lifetime) is determined. In some embodiments, the extent of usage of the engine 150 is determined as a numeric value based on an amount of operating time. In some embodiments, the amount of operating time is determined by an engine hour meter configured to directly monitor the operating time. Alternatively or additionally, the extent of usage of the engine 150 is determined as a numeric value based on a number of miles (e.g., mileage) traveled by the vehicle. In some embodiments, the mileage is tracked by the vehicle's odometer, which can also be used to estimate the operating time in some instances. In some embodiments, the numeric values corresponding to the amount of operating time and the number of mileage, respectively, are measured or estimated by sensors (e.g., the sensors 125) configured to monitor the engine 150's activities or by a GPS tracking system installed in the vehicle.

In some embodiments, the amount of operating time and/or the number of mileage are determined relative to a baseline condition of the engine 150. In some embodiments, the baseline condition corresponds to a condition of the engine 150 after initial production is completed, i.e., values corresponding to the operating time and the mileage are both set at approximately zero. In some embodiments, the baseline condition corresponds to a condition of the engine 150 after a service event is completed. The service event may include a rebuild of the engine or replacement of key components of the engine 150.

If the extent of usage of the engine 150, as reflected by the amount of operating time or the milage of the engine 150, is determined to be above a pre-determined threshold value at the operation 204, as indicated by an answer “NO,” the method 200 proceeds to the operation 206. On the contrary, if the extent of usage of the engine 150, as reflected by the amount of operating time or the milage, is determined to be at or below the pre-determined threshold value at the operation 204, as indicated by an answer “YES,” the method 200 proceeds to the operations 210-216, during which the treatment (e.g., de-greening) process is performed. The pre-determined threshold value may be an amount of operating time or a mileage determined based on specification of the engine 150 provided by the manufacturer. If the extent of usage is determined to be at or below the pre-determined threshold value, then the subsequent implementation of the operations 210-216 may be considered a pre-conditioning process on the engine 150.

In some embodiments, the pre-determined threshold value evaluated at the operation 204 is impacted by duty cycle of the engine. For example, a low duty cycle may correspond to a low-load condition during which less oil is consumed, and a high duty cycle may correspond to a high-load condition during which more oil is consumed. In this regard, if the engine 150 frequently operates at higher duty cycle conditions, the increased oil consumption would reduce the frequency of performing (or re-applying) the treatment process, leading to a higher pre-determined threshold value than if the engine 150 frequently operates at lower duty cycle conditions. It is noted, however, that a higher oil consumption may not always be a result of a higher duty cycle. For example, there are some applications that consume more oil at idle (e.g., no or very low applied load).

Since the combustion deposits can be naturally formed by the combustion of the oil during routine operations of an engine, the amount of the combustion deposits formed generally increases with an increased extent of usage. For example, the amount of the combustion deposits increases as each of the operating time and the milage of an engine increases. Accordingly, if the extent of usage is less than the pre-determined threshold value, then the amount of combustion deposits formed in the engine 150 is below a desired level, indicating that a treatment process is needed or at least beneficial for providing lubrication to the components of the engine 150.

At the operation 206, an amount of oil consumption of the engine 150, expressed as a numeric value, for example, is determined. The amount of oil consumption can be detected by, for example, regular monitoring of oil levels within the engine 150. Oil levels can be monitored in several ways, including checking a dipstick removably disposed within an engine that is configured to indicate the level of oil within the engine 150 (e.g., a removable metal extension with incremental marks corresponding to volumes of oil in an oil sump). Alternatively or additionally, oil levels can be monitored automatically in a vehicle equipped to detect and signal to a user problematically low oil levels (e.g., an e-dipstick, a digital oil level sensor, a “check oil” light on a vehicle's dashboard display, etc.). If regular monitoring reveals that the oil levels are depleting at an unusual or problematic rate, an elevated level of oil consumption is detected.

In some embodiments where oil levels are monitored automatically, the controller 140 is structured to perform certain operations to monitor the oil levels, among others. The controller 140 can form a portion of a processing sub-system including one or more computing devices having memory, processing, and communication hardware. The controller 140 may be a single device or a distributed device, and the functions of the controller 140 may be implemented by way of hardware, firmware, software, the like, or combinations thereof (e.g., such as by a processor executing computer instructions from a non-transient computer readable storage medium). The description herein emphasizes the structural independence of the aspects of the controller 140 and illustrates one grouping of operations and responsibilities of the controller 140, such as the monitoring of oil levels in the engine 150. Other groupings that execute similar overall operations are understood to be within the scope of the present disclosure.

In some embodiments, the controller 140 includes one or more modules structured to functionally execute the operations of the controller 140. In some embodiments, the controller 140 includes a sensor module 142 configured to determine a volume of oil in the engine 150 (e.g., a volume of oil in the oil pump 112) and an indicator module 144 configured to trigger a warning signal to the user (e.g., via a dashboard light indicator) when the oil level drops below a pre-determined threshold value (e.g., a minimum volume of oil required by the engine 150 to function).

If the amount of oil consumption of the engine 150 is determined to be below a pre-determined threshold value at the operation 208, as indicated by an answer “NO,” the method 200 proceeds to the operation 216, during which the engine 150 is operated under routine conditions. On the contrary, if the amount of oil consumption of the engine 150 is determined to be at or above the pre-determined threshold value at the operation 208 and within a range of controlled rate of oil consumption, as indicated by an answer “YES,” the method 200 proceeds to the operations 210-214, during which the treatment process is performed. However, if the amount of oil consumption is excessively high (i.e., the amount of oil remaining is exceedingly low), which may be caused by uncontrolled oil consumption, for example, then the treatment process at the operations 210-214 is not performed to avoid further depleting the remaining oil level available to the engine 150. As a result, the method 200 proceeds from the operation 208 to the operation 216, as indicated by a dashed portion of an arrow connecting the operation 208 to the operation 216 in FIG. 3. A non-limiting example of an excessively high level of oil consumption (e.g., an oil consumption rate failure) corresponds to consuming a quart of oil every 500 to 1,000 miles of operation.

Generally, for an engine operating at least partially on a non-hydrocarbon-based fuel (e.g., hydrogen), an elevated level of oil consumption (e.g., greater than the pre-determined threshold value but within the range of controlled rate of oil consumption described above), as determined at the operation 208, indicates that a lesser amount of the oil is available to form the combustion deposits as the solid lubricant, which may impact the lifespan of those components at higher risk of wear (e.g., the valve seats). Similarly, when the engine is fresh off the production line or has not been used extensively since a previous service event, as determined at the operation 204, a period over which the combustion deposits accumulate is limited in comparison to that of a more seasoned engine.

Accordingly, embodiments of the present disclosure are directed to methods of performing a treatment or conditioning process to engines having a depleted or limited amount of combustion deposits by creating (e.g., when the engine is fresh-off the production line or has undergone a rebuild or replacement) or accelerating (e.g., after the engine has been operating for an extended period of time or has consumed an excessively high amount of oil) the formation of the combustion deposits on components of the engine that are prone to wear, leading to improved engine performance. In this regard, the treatment process may be performed shortly after the engine exits the production line or undergoes a major service event, such as an engine rebuild or replacement of key components. Alternatively or additionally, the treatment process may be performed when an amount of oil consumption is above a pre-determined threshold value while remaining within the range of controlled rate of oil consumption.

In response to the determination that a treatment process is needed or beneficial based on the operations 202-208, the method 200 at the operation 210 proceeds to providing the engine with a treatment oil (alternatively referred to as a conditioning oil, a de-greening oil, or a treatment lubricating oil). The treatment oil includes a formulation based on modifications of a standard oil, which is utilized by the engine 150 under routine conditions, such as prior to and/or after performing the treatment process. For example, the treatment oil includes the formulation of the standard oil and one or more additives configured to accelerate solid deposit formation to enhance lubrication of certain components (e.g., implemented at the operation 214). In some embodiments, the treatment oil includes an ash additive and/or any other solid material capable of withstanding combustion at elevated temperature without volatilization, which typically occurs at or below approximately 75° C. In the present disclosure, the term “standard oil” refers to an oil that does not include a formulation configured specifically for the treatment process described herein, such as the formulation including the ash additive.

The treatment oil may further include lubricant additives typically found in the standard oil for gasoline and diesel engine applications. These can include, for example, oxidation inhibitors, dispersants, metallic and non-metallic detergents, corrosion and rust inhibitors such as borate esters, metal deactivators, anti-wear agents, extreme pressure additives, pour point depressants, viscosity modifiers, seal compatibility agents, friction modifiers, defoamants, demulsifiers, the like, or combinations thereof.

In some embodiments, providing the engine 150 with the treatment oil includes filling the engine 150 with the treatment oil. For example, if the engine 150 is fresh off the production line or has recently undergone a rebuild, instead of filling the engine 150 with the standard oil, the treatment oil is filled as the initial oil before subsequently performing the treatment process.

In some embodiments, providing the engine 150 with the treatment oil includes replacing the standard oil present in the engine 150 with the treatment oil. For example, the standard oil is first drained from the oil circulation system 107. The engine 150 is then filled with a filling treatment oil, which has a formulation of the treatment oil as described above, by closing the oil sump 110 and filling the engine 150 with a pre-determined amount of the filling treatment oil (e.g., equivalent to the appropriate amount of standard oil as called for by the engine's specifications). In some embodiments, the engine 150 is filled with the filling treatment oil only. In some embodiments, the engine 150 is filled with a mixture of the standard oil and the filling treatment oil at a pre-determined ratio. In some embodiments, after draining the standard oil, the engine 150 is flushed with a flushing treatment oil, which is subsequently drained before filling the engine 150 with the filling treatment oil.

In some embodiments, as an alternative to replacing with the treatment oil, providing the engine 150 with the treatment oil includes directly dosing the standard oil already present in the engine 150 with one or more of the additives configured to accelerate solid deposit formation to enhance lubrication of certain components. For example, without performing a draining process, the standard oil present in the oil circulation system 107 is dosed with the ash additive described above to accommodate the subsequent implementation of the treatment process. In some examples, dosing the standard oil with one or more of the additives allows the amount of the additives be adjusted to a desired level to meet certain performance targets at a reduced cost by using any existing oil in the engine.

In some embodiments, the amount of the ash additive in the formulation of the treatment oil (or otherwise dosed in the standard oil) is determined based on an estimated amount of the solid deposits present in the engine 150, which can be correlated with the operating parameters evaluated at the operations 202-208. In this regard, the amount of the ash additive in the formulation is generally greater for engines with less usage (e.g., fresh-off the production line, recently rebuilt or repaired, etc.) than for those with more usage. Similarly, the amount of the ash additive in the formulation is generally greater for engines detected with higher levels of oil consumption than for those with lower levels of oil consumption.

For engines utilizing a combination of a hydrocarbon-based fuel and a non-hydrocarbon-based fuel (or a low-hydrocarbon-based fuel), such as hydrogen, the amount of the ash additive in the formulation of the treatment oil (or otherwise dosed in the standard oil) can be further determined based on a substitution rate of the non-hydrocarbon-based fuel (or the low-hydrocarbon-based fuel) with respect to the hydrocarbon-based fuel. For example, the amount of the ash additive in the formulation is generally greater for engines utilizing a combination fuel having a higher substitution rate, i.e., the engines utilizing a higher amount of the non-hydrocarbon-based fuel in the fuel combination, than for those utilizing a combination fuel with a lower substitution rate.

In some embodiments, the operation 210 is omitted such that the method 200 proceeds from the operation 204 or the operation 208 to the operation 212 directly. In this regard, the treatment process at the operations 212 and 214 is implemented using only the standard oil present in the engine 150.

At the operation 212, the engine 150 is operated under a first condition during which a greater amount of oil is consumed by the engine 150 than is otherwise necessary based on the vehicle's routine usage conditions. The first condition is created to intentionally allow more oil, such as the treatment oil, the standard oil dosed with the ash additive, or the standard oil only, to be provided to the cylinder 105 (i.e., the combustion chamber) of the engine 150, where it can be subsequently ignited and combusted.

In some embodiments, the first condition subjects the engine 150 to one or more duty cycles (e.g., load cycles) that naturally consume elevated amounts of oil based on a design of the engine 150. In some embodiments, the engine 150 is operated at a low-duty cycle (e.g., with a relatively lower load) under the first condition. For example, the first condition may include operating the engine 150 without applying an external load, i.e., idling the engine 150. Idling the engine 150 may create negative pressure within the cylinder 105, thereby pulling the oil past the piston 106 and/or the valve 102 and into the cylinder 105, where the oil is subsequently ignited with the fuel and air at each combustion cycle to form the combustion by-products.

Alternatively or additionally, instead of relying on certain duty cycles (e.g., natural points during the engine's operation cycles) to control the amount of oil consumption in the engine 150 under the first condition, the amount of oil consumption may be directly controlled by adjusting the amount of on-board lubricant metered in the engine 150.

Subsequently, at the operation 214, the engine 150 is operated under a second condition during which a temperature within the engine 150 is increased. The second condition is intentionally created to raise the temperature within the engine 150, following the formation of the combustion by-products at the operation 212. In some embodiments, the engine 150 is operated at a high-duty cycle under the second condition. For example, the engine 150 under the second condition is subject to a higher load than under the first condition, causing the temperature of the engine 150 to increase. In some embodiments, the temperature is high enough so as to bake the carbon-based and ash-based by-products onto the components of the engine 150, thereby forming the solid lubricant to improve the wear resistance and the lifespan of the components.

In some embodiments, the temperature of the engine 150 can be adjusted to control a period over which the engine 150 is operated under the second condition. For example, increasing the load applied to the engine 150 under the second condition leads to a shortened duration for such operation, and decreasing the load applied to the engine 150 under the second condition leads to an increased duration for such operation. In some examples, a certain amount of the combustion by-products can also be baked or deposited onto the components of the engine 150 when the engine is operated under the first condition, although a rate of such deposition is less than that obtained under the second condition due to the lower temperature achieved under the first condition. In some embodiments, the engine 150 is operated at a suitable duty cycle under the second condition to achieve the highest temperature possible (e.g., a maximum engine temperature) without volatilizing the oil, such that the duration of the treatment process can be reduced or minimized.

In some embodiments, the operations 212 and 214 are performed cyclically, as indicated by a dashed arrow connecting the operation 212 to the operation 214 in FIG. 3, for a pre-determined number of cycles to ensure a sufficient amount of combustion deposits are formed on the components of the engine 150. In some examples, the sufficient amount of combustion deposits may be determined by correlating conditions of the operations 212 and 214, such as the temperature and/or the amount of oil (e.g., the treatment oil, the standard oil dosed with the additives, etc.) consumed to a set of test data obtained in a controlled setting. The pre-determined number of cycles may vary based on the temperature achieved (or load applied) under the second condition. In some embodiments, the number of cycles alternating between the first condition and the second condition of the treatment process varies inversely with the temperature achieved in the engine 150 under the second condition. For example, if the second condition results in a relatively lower temperature, then a same amount of the combustion by-products obtained from operating the engine 150 under the first condition may require a greater number of cycles to be baked onto the components of the engine 150 than if the second condition results in a relatively higher temperature.

At the operation 216, after completing the treatment process, operating the engine 150 under routine conditions is resumed. In some embodiments, the engine 150 operated under the routine conditions generally consumes less oil than under the first condition. In some embodiments, the engine 150 continues to be operated under the routine conditions until it undergoes a service event, such as an oil change, a rebuild, or replacement of key components, after which another treatment process may be applied to the engine 150 according to the embodiments provided herein. In some embodiments, the engine 150 continues to be operated under the routine conditions until an unusually low oil level or an unusually high level of oil consumption is detected, after which another treatment process may be applied to the engine 150 according to the embodiments provided herein.

In another aspect of the present disclosure, instead of evaluating a first threshold value that corresponds to the extent of engine usage (e.g., at the operations 202 and 204) and/or evaluating a second threshold value that corresponds to the amount of oil consumption of the engine (e.g., at the operations 206 and 208), the treatment process at the operations 210-214 may be performed (i.e., the engine is re-treated) at regular intervals that correspond to the extent of engine usage, such as after a pre-determined hours of engine use or a pre-determined mileage. In some examples, the intervals may be tracked by an engine hour counter or a mileage counter that counts down after an initial threshold (e.g., the first threshold value evaluated at the operation 202 and 204) is reached during an initial treatment process.

It should be noted that the orientation of various elements (e.g., “top,” “bottom,” etc.) may differ according to other exemplary embodiments, and that such variations are intended to be encompassed by the present disclosure. It is recognized that features of the disclosed embodiments can be incorporated into other disclosed embodiments.

It is important to note that the constructions and embodiments of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that, unless otherwise noted, any parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The indefinite articles “a” and “an,” as used herein in the specification and in the claims, unless clearly indicated to the contrary, should be understood to mean “at least one.”

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method of performing a treatment process on an internal combustion engine, comprising:
determining an extent of usage of the internal combustion engine;
comparing the extent of usage with a threshold value;
in response to determining that the extent of usage is at or below the threshold value, operating the internal combustion engine under a first condition during which a lubricating oil in the internal combustion engine is combusted to form a combustion by-product; and
operating the internal combustion engine under a second condition during which the combustion by-product is deposited onto components of the internal combustion engine.

2. The method of claim 1, further comprising, before operating the internal combustion engine under the first condition, providing the internal combustion engine with a treatment oil such that the lubricating oil comprises the treatment oil, wherein the treatment oil comprises an ash additive.

3. The method of claim 2, wherein the providing the internal combustion engine with the treatment oil comprises determining an amount of the ash additive in the treatment oil based on the determined extent of usage.

4. The method of claim 1, wherein the operating of the internal combustion engine under the first condition comprises subjecting the internal combustion engine to a first load and the operating of the internal combustion engine under the second condition comprises subjecting the internal combustion engine to a second load that is greater than the first load.

5. The method of claim 1, wherein the operating of the internal combustion engine under the first condition and the operating of the internal combustion engine under the second condition are implemented cyclically.

6. The method of claim 1, wherein the determining of the extent of usage comprises determining at least one of mileage and operating time of the internal combustion engine.

7. The method of claim 1, wherein the determining of the extent of usage is relative to a baseline condition that corresponds to a condition of the internal combustion engine after initial production is completed, a rebuild of the internal combustion engine, or a replacement of a key component of the internal combustion engine.

8. The method of claim 1, wherein:
the threshold value is a first threshold value, and
the method further comprises, in response to determining that the extent of usage is above the first threshold value:
determining an amount of the lubricating oil consumed by the internal combustion engine,
comparing the amount with a second threshold value,
in response to determining that the amount is at or above the second threshold value, operating the internal combustion engine under the first condition, and
operating the internal combustion engine under the second condition.

9. A method of performing a treatment process on an internal combustion engine, comprising:
determining an amount of a lubricating oil consumed by the internal combustion engine;
comparing the amount with a threshold value;
in response to determining that the amount is at or above the threshold value, operating the internal combustion engine under a first condition during which the lubricating oil in the internal combustion engine is combusted to form a combustion by-product; and
operating the internal combustion engine under a second condition during which the combustion by-product is deposited onto components of the internal combustion engine.

10. The method of claim 9, wherein:
the threshold value is a first threshold value, and
the method further comprises, before determining the amount of the lubricating oil consumed, determining that an extent of usage of the internal combustion engine is above a second threshold value.

11. The method of claim 10, wherein the determining of the extent of usage comprises tracking the extent of usage using an engine hour counter or a mileage counter.

12. The method of claim 9, wherein the method further comprises, before operating the internal combustion engine under the first condition, providing the internal combustion engine with the lubricating oil, the lubricating oil comprising an ash additive and a standard oil.

13. The method of claim 12, wherein the providing the internal combustion engine with the lubricating oil comprises dosing the standard oil with the ash additive.

14. The method of claim 12, wherein the providing the internal combustion engine with the lubricating oil comprises filling the internal combustion engine with a mixture of a treatment oil and the standard oil, wherein the treatment oil comprises the ash additive.

15. The method of claim 12, wherein the providing the internal combustion engine with the lubricating oil comprises determining an amount of the ash additive in the lubricating oil based on the determined amount of the lubricating oil consumed.

16. The method of claim 9, wherein the operating of the internal combustion engine under the first condition comprises operating the internal combustion engine at a low-duty cycle and the operating of internal combustion engine under the second condition comprises operating the internal combustion engine at a high-duty cycle.

17. The method of claim 9, wherein the operating the internal combustion engine under the first condition comprises adjusting an amount of the lubricating oil metered in the internal combustion engine.

18. The method of claim 9, further comprising, in response to determining that the amount is at or above the threshold value, operating the internal combustion engine under routine conditions.

19. An internal combustion engine system, comprising:
an internal combustion engine; and
a controller communicatively coupled to the internal combustion engine and configured to:
determine an extent of usage of the internal combustion engine relative to a threshold value;
in response to determining that the extent of usage is at or below the threshold value, operate the internal combustion engine under a first condition during which a lubricating oil in the internal combustion engine is combusted to form a combustion by-product; and
operate the internal combustion engine under a second condition during which a temperature within the internal combustion engine is increased, thereby depositing the combustion by-product onto components of the internal combustion engine.

20. The internal combustion engine system of claim 19, further comprising at least sensor communicatively coupled to the internal combustion engine and the controller, wherein the controller is configured to determine the extent of usage based on data received from the at least one sensor that correspond to at least one of mileage and operating time of the internal combustion engine.
